(19) United States
(12) Patent Application Publication
(10) Pub. No.: US 2002/0003462 A1
(43) Pub. Date: Jan. 10, 2002

(54) Electromagnet device

(76) Inventor: Thomas Stolk, Kirchheim (DE)

Correspondence Address: KENYON & KENYON, ONE BROADWAY, NEW YORK, NY, 10004, US

(21) Appl. No.: 09/838,098

(22) Filed: Apr. 19, 2001

(30) Foreign Application Priority Data
Apr. 19, 2000 (DE) 100 19 412.5

(51) Int. Cl. H01F 7/08

(52) U.S. Cl. 335/220

(57) ABSTRACT

An electromagnet device includes at least one electromagnet having at least one coil and at least one core built up from laminations. At least individual laminations are connected and reinforced by at least one profiled element.

### FIELD OF THE INVENTION

The present invention relates to an electromagnet device.

### BACKGROUND INFORMATION

To generate the strongest possible electromagnetic fields, generally electromagnets with a coil and a ferromagnetic core are used. The core is located in the coil and/or surrounds the coil. If a current is passed through the coil, a magnetic field with the field strength H builds up around the coil in accordance with Ampere's law. Under the effect of the force of the magnetic field, the magnetic dipoles present in the core material orientate themselves in the direction of the field, also referred to as diffusion, and increase the magnetic flux density or induction in comparison with an air coil from B₀ to B. The resulting magnetic field is consequently dependent on the field strength H and the flux density B. Self-induction acts in the coil, so that the current and the field strength H dependent on the current increase with a delay. Furthermore, the build-up of the magnetic field is delayed by eddy currents developing in the core material, which hinder the diffusion of the magnetic field in the core and result in losses.

To achieve a short response time in an electromagnet, the electromagnetic field should be built up and also allowed to decay again quickly and, in spite of small dimensions of the electromagnet, a large final force should be achieved, in particular in very dynamic systems, such as, actuators for actuating gas-exchange valves of internal combustion engines.

To avoid eddy currents, iron cores have been built up from thin laminations which are insulated from one another and the contact surfaces of which are aligned transversely in relation to electric flux lines occurring, i.e., perpendicular to the winding of the coil (cf. H. Linse, Elektrotechnik für Maschinenbauer (Electrical Engineering for Machine Makers), 8th, revised edition, Teubner 1987, page 66 et seq.). It is desirable that only small voltages, and consequently no eddy currents, occur in the laminations. The laminations are either welded or crimped to one another.

### SUMMARY

It is an object of the present invention to provide an electromagnet device with laminated iron cores and having improved efficiency.

The above and other beneficial objects of the present invention are attained by providing an electromagnet device having at least one electromagnet, which has at least one coil and at least one core built up from laminations.

At least individual laminations are connected and reinforced by at least one profiled element. Despite the core being built up from individual laminations, improved rigidity may be achieved and undesired deformations of the laminated core and an associated air gap between an armature and a pole face of the core may be substantially avoided and the efficiency may be increased.

To achieve high torsional rigidity and/or flexural rigidity, the profiled element may include various profiles, such as, for example, a T profile, a U profile with indentations, beads, etc. Improved torsional rigidity may be achieved with a hollow profile, such as, for example, with a “D-box profile”, which includes a D-shaped cross-sectional surface. To achieve not only improved torsional rigidity but also improved flexural rigidity, the hollow profile may, furthermore, be combined with further profiles, for example, with a U profile, etc.

The profiled element may at least partially bound a channel, such as, for example, a cooling channel. Other channels may also be bounded by the profiled element, such as, for example, cable ducts, etc. Additional components, installation space, weight and assembly effort may be reduced. A coolant may be passed directly over the laminations of the core or over a coil, whereby improved heat removal may be achieved. Furthermore, the channel may be made in a hollow profile of the profiled element, whereby direct contact between the coolant and the core may be avoided. A closed cooling system may be achieved in a simple way, and it is possible to avoid designing the core, in terms of its material, for the coolant, or vice versa.

The core may be supported on at least one bearing surface by the profiled element. Bearing forces may be absorbed via the profiled element and additional components may be reduced. To allow compensation for play and to make contact of an armature against a pole face of the core possible, the core may be guided movably on a bearing surface by the profiled element. That is, the profiled element may include at least a round outer contour, by which the core is pivotably mounted. It is possible to compensate for an air gap between the armature and the pole face, and to increase the efficiency, by a pivoting movement of the core.

The profiled element may be connected to the laminations by various integral, positive and/or non-positive connections, such as, for example, by a welded connection, a screwed connection, a clamping and/or engaging connection, etc. The profiled element may be connected non-positively and/or positively to the laminations, thereby allowing a propagation of eddy currents via the profiled element simply to be substantially avoided. The profiled element may be formed from various materials, such as, for example, from steel, a fibre composite material, etc.

The profiled element may be integrally connected to at least one carrier part, whereby the rigidity of the core may be further increased. The integral connection may be achieved by various methods, for example, at the end face by an adhesive, soldered and/or welded connection. The profiled element and the carrier part may be configured in an overlapping manner and welded in a fillet weld. The fillet weld may be made with a large weld volume, and low material loading and a particularly solid connection may be achieved.

The electromagnet device according to the present invention may be used in various devices, such as those subjected to high mechanical loads and required to meet high rigidity requirements, such as electromagnetic actuators for actuating gas-exchange valves in internal combustion engines.

### BRIEF DESCRIPTION OF THE DRAWINGS

FIG. 1 is a schematic cross-sectional view through an actuator from above.

FIG. 2 is a side view of the actuator illustrated in FIG. 1.

FIG. 3 is a schematic cross-sectional view of an actuator with profiled elements having a hollow profile.

### DETAILED DESCRIPTION

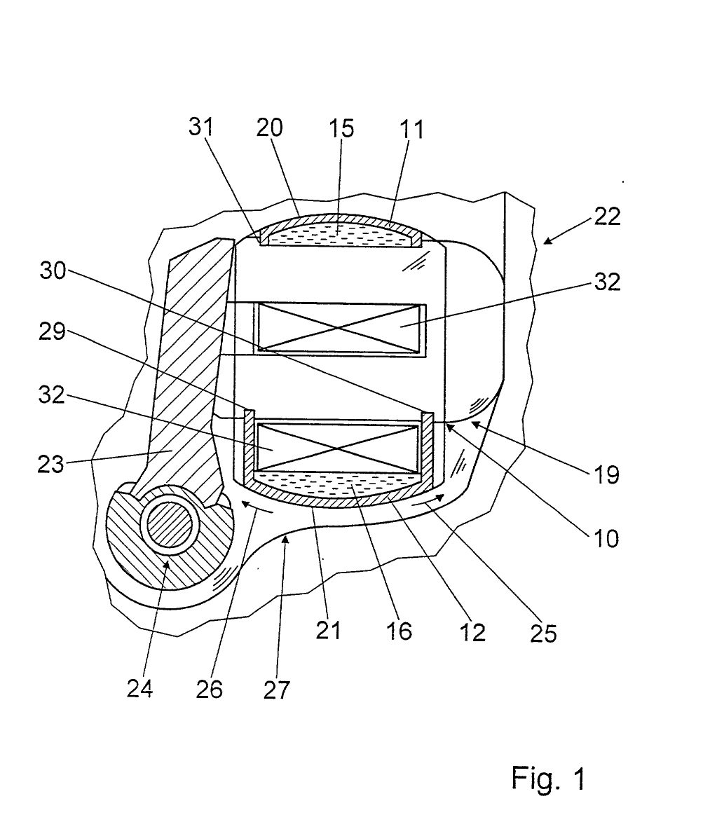

FIG. 1 illustrates an electromagnetic actuator with an electromagnet 22 for actuating a gas-exchange valve (not illustrated in detail) of an internal combustion engine. The electromagnet 22 acts on a rotating armature 23, which is pivotably mounted in a bearing 24.

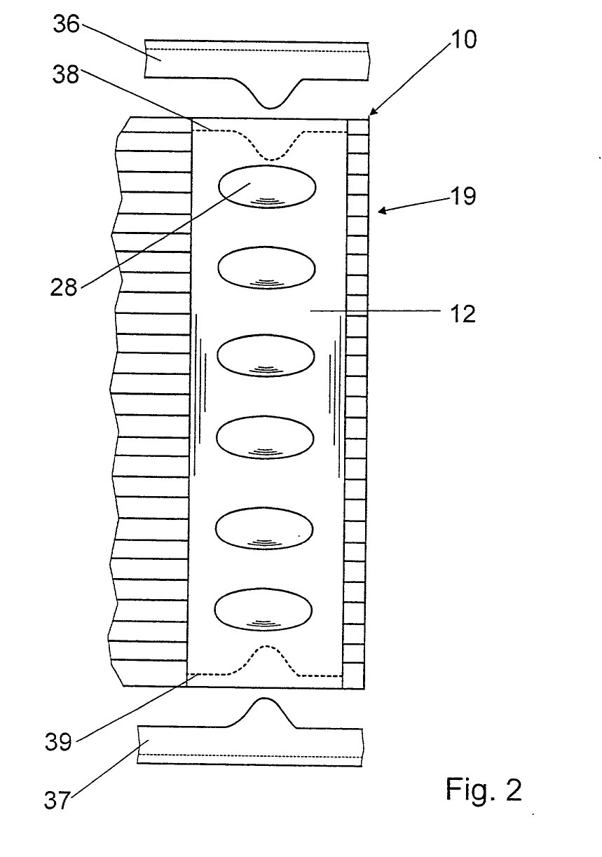

The electromagnet 22 includes a coil 32 and a core 19, which is built up from thin laminations 10 which are insulated from one another and the contact surfaces of which are arranged transversely in relation to electric flux lines (FIG. 2). According to the present invention, the laminations 10 are connected and reinforced by two profiled elements 11, 12. The profiled elements 11, 12 engage positively in recesses 29, 30, 31 of the laminations 10 and with these are braced with the laminations 10 non-positively in addition to a positive engagement (FIG. 1).

The profiled elements 11, 12 include a U profile with a bottom part and two legs. The bottom part is configured so that it curves outwardly and, as a result, has a round outer contour, by which the core 19 is pivotably mounted on bearing surfaces 20, 21 in a carrier device 27. It is possible by a pivoting movement 25, 26 to compensate for an air gap between the rotating armature 23 and pole faces of the electromagnet 22.

Instead of making the core 19 constantly pivotable, prior to being put into operation for the first time, it may also be set to the rotating armature 23 or pivoted into a desired position and subsequently welded to carrier plates 36, 37, as illustrated in FIG. 2. Like components are designated by the same reference numerals throughout the several views. In the finished assembled state, the carrier plates 36, 37 and the profiled element 12 are configured in an overlapping manner and are welded to one another by a curve-shaped fillet weld 38, 39. In order to increase the rigidity further, indentations 28 may be made on a side of the profiled elements 12 facing away from the core.

The profiled elements 11, 12 bound a cooling channel 15, 16 outwardly, one cooling channel 15 being bounded inwardly by the laminations 10 and one cooling channel 16 being bounded inwardly by the coil 32.

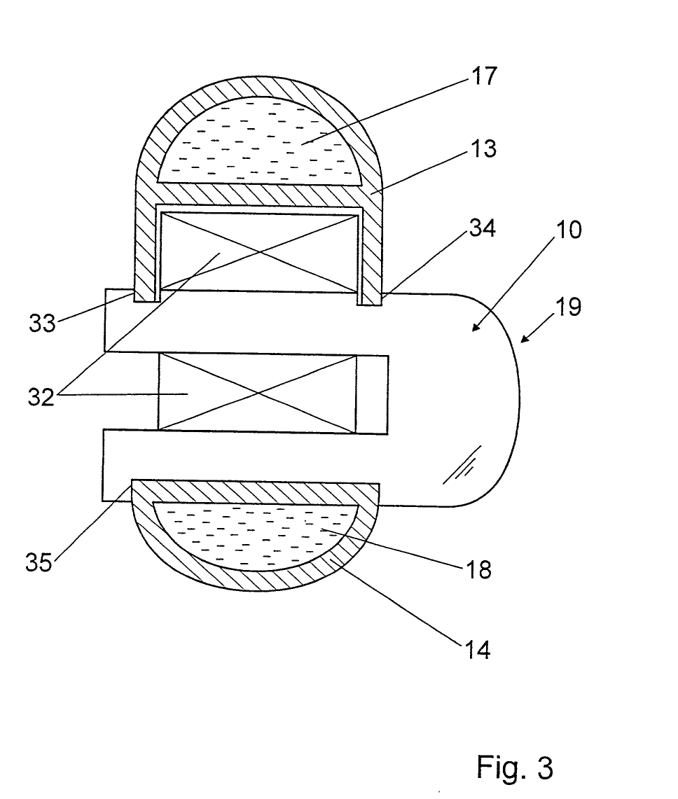

FIG. 3 illustrates another example embodiment of the present invention. With respect to features and functions which remain the same, reference can be made to the description of the example embodiments illustrated in FIGS. 1 and 2.

The laminations 10 of the core 19 are connected and reinforced by two profiled elements 13, 14, which engage positively in recesses 33, 34, 35 of the laminations 10 and, in addition to a positive connection, are non-positively braced with the laminations 10. Both profiled elements 13, 14 include a hollow profile with a D-shaped cross-sectional surface, i.e., a “D box”, in which cooling channels 17, 18 are made. Other profile shapes are also possible. The D-shaped cross-sectional surface produces a round outer contour, by which the core 19 may be mounted in a pivotable manner. Furthermore, improved torsional rigidity is achieved. The terminating profiled element 13 with respect to the coil 32 additionally includes a U profile, with which it reaches around the coil 32. The U profile achieves improved flexural rigidity in addition to improved torsional rigidity.

What is claimed is:

1. An device comprising at least one electromagnet, the at least one electromagnet including:
at least one coil;
at least one core including a plurality of laminations; and
at least one profiled element configured connect and reinforce at least individual laminations.

2. The electromagnet device according to claim 1, wherein the profiled element includes a hollow profile.

3. The electromagnet device according to claim 1, wherein the profile element at least partially bounds a channel.

4. The electromagnet device according to claim 3, wherein the channel is configured to carry a coolant.

5. The device according to claim 1, wherein the at least one profiled element is further configured to support the core on at least one bearing surface.

6. The device according to claim 5, wherein the at least one profiled element is further configured to guidably move the core on the at least one bearing surface.

7. The device according to claim 6, wherein the at least one profiled element includes at least a partially round outer contour configured to pivotably mount the core.

8. The device according to claim 1, wherein the at least one profiled element is at least one of non-positively and positively connected to the laminations.

9. The device according to claim 1, further comprising at least one carrier part, the at least one profiled element being integrally connected to the at least one carrier part.

10. The device according to claim 9, wherein the at least one profiled element and the at least one carrier part are configured to overlap and are configured to be welded in a fillet weld.

11. The device according to claim 9, wherein the at least one profiled element and the at least one carrier part overlap and are welded in a fillet weld.

12. The device according to claim 1, further comprising a gas-exchange valve of an internal combustion engine, the gas-exchange valve being actuatable in accordance with the at least one electromagnet.

13. The device according to claim 1, wherein the electromagnet is configured to actuate a gas-exchange valve of an internal combustion engine.
